(19) United States
(12) Patent Application Publication
(10) Pub. No.: US 2016/0281015 A1
(43) Pub. Date: Sep. 29, 2016

(54) METHODS FOR PREPARING ANTI-FRICTION COATINGS

(71) Applicants: Lei Zhao, Houston, TX (US); Zhiyue Xu, Cypress, TX (US)

(72) Inventors: Lei Zhao, Houston, TX (US); Zhiyue Xu, Cypress, TX (US)

(73) Assignee: Baker Hughes Incorporated, Houston, TX (US)

(21) Appl. No.: 15/173,762

(22) Filed: Jun. 6, 2016

Related U.S. Application Data
(62) Division of application No. 14/534,331, filed on Nov. 6, 2014.

(51) Int. Cl. C10M 103/02; B32B 37/12; B32B 37/06; C10M 103/04

(52) U.S. Cl. CPC C10M 103/02; C10M 103/04; B32B 37/1207; B32B 37/06; C10M 2201/0613; C10M 2201/0873; C10N 2250/08; C10N 2230/08; B32B 2255/00

(57) ABSTRACT

An article comprises a substrate; a coating comprising a carbon composite; and a binding layer disposed between the substrate and the coating. The carbon composite comprises carbon and a binder containing one or more of the following: SiO₂; Si; B; B₂O₃; a metal; or an alloy of the metal; and the metal comprises one or more of the following: aluminum; copper; titanium; nickel; tungsten; chromium; iron; manganese; zirconium; hafnium; vanadium; niobium; molybdenum; tin; bismuth; antimony; lead; cadmium; or selenium.

### CROSS-REFERENCE TO RELATED APPLICATION

This application is a divisional application of U.S. patent application Ser. No. 14/534,331, filed Nov. 6, 2014, the disclosure of which is incorporated by reference herein in its entirety.

### BACKGROUND

Dry film coatings have been widely used on machine or tool parts in order to protect these parts from galling, seizing, or wearing. Most of the dry film coatings are organic based which either use organic lubricants or require polymeric materials to bond inorganic lubricants to the substrate to be protected. While organic based dry film coatings have proved satisfactory for most applications, difficulties can arise when the machine or tool parts are used in harsh operating conditions and environmental extremes. These conditions can include high temperatures where organics are prone to degradation or decomposition, extremely low temperatures where liquid lubricants may solidify or freeze, and low pressure or high vacuum applications where lubricants may vaporize. Accordingly, advances in methods and materials to ameliorate environmental effects on lubricants and coatings are well received by the industry.

### BRIEF DESCRIPTION

The above and other deficiencies in the prior art are overcome by, in an embodiment, an article comprises a substrate; a coating comprising a carbon composite; and a binding layer disposed between the substrate and the coating; wherein the carbon composite comprises carbon and a binder containing one or more of the following: SiO₂; Si; B; B₂O₃; a metal; or an alloy of the metal; and the metal comprises one or more of the following: aluminum; copper; titanium; nickel; tungsten; chromium; iron; manganese; zirconium; hafnium; vanadium; niobium; molybdenum; tin; bismuth; antimony; lead; cadmium; or selenium.

A method for coating a substrate comprises disposing a coating on a substrate, the coating comprising a carbon composite foil; and binding the coating to the substrate.

### BRIEF DESCRIPTION OF THE DRAWINGS

The following descriptions should not be considered limiting in any way. With reference to the accompanying drawings, like elements are numbered alike:

FIG. 1 is a schematic illustration of an article according to an embodiment of the disclosure; and

FIG. 2 illustrates an exemplary process to coat a substrate using electrical joining techniques;

FIG. 3 illustrates an article having an activation foil disposed between a carbon composite coating and a substrate; and

FIG. 4 shows the friction testing results of various materials.

### DETAILED DESCRIPTION

Compared with organic based lubricants, graphite has many advantages including superior lubrication at high temperatures and corrosive environments. However, due to the high graphitization temperature of the carbon materials (usually greater than 1500° C.), it is impractical to directly deposit graphite materials onto metal articles. In order to achieve robust graphite coating, graphite particles can be dispersed in blends of resin and solvents, and then coated on metal surface. Even though a lubricating film can be formed in this method, the existence of organics in the coating severely limits its applications in extreme conditions such as high pressure, high temperature, and sour environments.

The inventors hereof have developed simple and robust processes to coat graphite on metal or ceramic substrates. Advantageously, graphite is used together with an inorganic binder forming a carbon composite. The presence of the inorganic binder in the coating significantly improves the mechanical strength of the graphite. Meanwhile, the inorganic binder facilitates the binding of the coating to the substrate. These processes eliminate resins and solvents typically required by prior art processes thus afford coatings having reliable and efficient lubrication up to 450° C. even in high pressure, high temperature, and corrosive environments. In a further advantageous feature, the coatings provide dry and clean lubrication unaffected by dust, dirt and moisture. In addition, the coatings can also have lifetime lubrication without aging, evaporation, or oxidation.

In an embodiment, there is provided an article comprising a substrate; a coating comprising a carbon composite; and a binding layer disposed between the substrate and the coating, wherein the carbon composite comprises graphite and an inorganic binder.

The substrate can be a metal or a ceramic material. It can be used without surface processing or can be processed, including chemically, physically, or mechanically treating the substrate. For example, the substrate can be treated to roughen or increase a surface area of the substrate, e.g., by sanding, lapping, or sand blasting. A surface of the substrate can also be cleaned to remove contaminants through chemical and/or mechanical means.

The metal of the substrate includes elements from Group 1 to Group 12 of the periodic table, alloys thereof, or a combination thereof. Exemplary metals are magnesium, aluminum, titanium, manganese, iron, cobalt, nickel, copper, molybdenum, tungsten, palladium, chromium, ruthenium, gold, silver, zinc, zirconium, vanadium, silicon, or a combination thereof, including alloys thereof. Metal alloys include, for example, an aluminum-based alloy, magnesium-based alloy, tungsten-based alloy, cobalt-based alloy, iron-based alloy, nickel-based alloy, cobalt and nickel-based alloy, iron and nickel-based alloy, iron and cobalt-based alloy, copper-based alloy, and titanium-based alloy. As used herein, the term “metal-based alloy” means a metal alloy wherein the weight percentage of the specified metal in the alloy is greater than the weight percentage of any other component of the alloy, based on the total weight of the alloy. Exemplary metal alloys include steel, nichrome, brass, pewter, bronze, invar, inconel, hastelloy, MgZrZn, MgAlZn, AlCuZnMn, and AlMgZnSiMn.

The ceramic is not particularly limited and can be selected depending on the particular application of the substrate that has been coated with the carbon composite coating. Examples of the ceramic include an oxide-based ceramic, nitride-based ceramic, carbide-based ceramic, boride-based ceramic, silicide-based ceramic, or a combination thereof. In an embodiment, the oxide-based ceramic is silica (SiO₂) or titania (TiO₂). The oxide-based ceramic, nitride-based ceramic, carbide-based ceramic, boride-based ceramic, or silicide-based ceramic can contain a nonmetal (e.g., oxygen, nitrogen, boron, carbon, or silicon, and the like), metal (e.g., aluminum, lead, bismuth, and the like), transition metal (e.g., niobium, tungsten, titanium, zirconium, hafnium, yttrium, and the like), alkali metal (e.g., lithium, potassium, and the like), alkaline earth metal (e.g., calcium, magnesium, strontium, and the like), rare earth (e.g., lanthanum, cerium, and the like), or halogen (e.g., fluorine, chlorine, and the like).

The substrate can be any shape. Exemplary shapes include a cube, sphere, cylinder, toroid, polygonal shape, helix, truncated shape thereof, or a combination thereof. The longest linear dimension of the substrate can be from 500 nm to hundreds of meters, without limitation. The substrate can have a thermal decomposition temperature that can withstand, without decomposition or degradation, exposure to a temperature from −10° C. to 800° C. However, coating disposed on the substrate can provide temperature shielding or thermal conductance to carry heat away from the substrate so that the substrate does not experience a temperature near its thermal decomposition temperature.

The coating comprises a carbon composite, which contains carbon and an inorganic binder. The carbon can be graphite. As used herein, graphite includes one or more of natural graphite; synthetic graphite; expandable graphite; or expanded graphite. Natural graphite is graphite formed by Nature. It can be classified as “flake” graphite, “vein” graphite, and “amorphous” graphite. Synthetic graphite is a manufactured product made from carbon materials. Pyrolytic graphite is one form of the synthetic graphite. Expandable graphite refers to graphite having intercallant materials inserted between layers of natural graphite or synthetic graphite. A wide variety of chemicals have been used to intercalate graphite materials. These include acids, oxidants, halides, or the like. Exemplary intercallant materials include sulfuric acid, nitric acid, chromic acid, boric acid, SO₃, or halides such as FeCl₃, ZnCl₂, and SbCl₅ Upon heating, the intercallant is converted from a liquid or solid state to a gas phase. Gas formation generates pressure which pushes adjacent carbon layers apart resulting in expanded graphite. The expanded graphite particles are vermiform in appearance, and are therefore commonly referred to as worms.

In an embodiment, the carbon composites comprise carbon microstructures having interstitial spaces among the carbon microstructures; wherein the binder is disposed in at least some of the interstitial spaces. In an embodiment, the carbon microstructures comprise unfilled voids within the carbon microstructures. In another embodiment, both the interstitial spaces among the carbon microstructures and the voids within the carbon microstructures are filled with the binder or a derivative thereof

The carbon microstructures are microscopic structures of graphite formed after compressing graphite into highly condensed state. They comprise graphite basal planes stacked together along the compression direction. As used herein, carbon basal planes refer to substantially flat, parallel sheets or layers of carbon atoms, where each sheet or layer has a single atom thickness. The graphite basal planes are also referred to as carbon layers. The carbon microstructures are generally flat and thin. They can have different shapes and can also be referred to as micro-flakes, micro-discs and the like. In an embodiment, the carbon microstructures are substantially parallel to each other.

There are two types of voids in the carbon composites—voids or interstitial spaces among carbon microstructures and voids within each individual carbon microstructures. The interstitial spaces among the carbon microstructures have a size of about 0.1 to about 100 microns, specifically about 1 to about 20 microns whereas the voids within the carbon microstructures are much smaller and are generally between about 20 nanometers to about 1 micron, specifically about 200 nanometers to about 1 micron. The shape of the voids or interstitial spaces is not particularly limited. As used herein, the size of the voids or interstitial spaces refers to the largest dimension of the voids or interstitial spaces and can be determined by high resolution electron or atomic force microscope technology.

The interstitial spaces among the carbon microstructures are filled with a micro- or nano-sized binder. For example, a binder can occupy about 10% to about 90% of the interstitial spaces among the carbon microstructures. In an embodiment, the binder does not penetrate the individual carbon microstructures and the voids within the carbon microstructures are unfilled, i.e., not filled with any binder. Thus the carbon layers within the carbon microstructures are not locked together by a binder. Through this mechanism, the flexibility of the carbon composites, particularly, expanded carbon composites can be preserved. In another embodiment, to achieve high strength, the voids within the carbon microstructures are filled with the binder or a derivative thereof. Methods to fill the voids within the carbon microstructures include vapor deposition.

The carbon microstructures have a thickness of about 1 to about 200 microns, about 1 to about 150 microns, about 1 to about 100 microns, about 1 to about 50 microns, or about 10 to about 20 microns. The diameter or largest dimension of the carbon microstructures is about 5 to about 500 microns or about 10 to about 500 microns. The aspect ratio of the carbon microstructures can be about 10 to about 500, about 20 to about 400, or about 25 to about 350. In an embodiment, the distance between the carbon layers in the carbon microstructures is about 0.3 nanometers to about 1 micron. The carbon microstructures can have a density of about 0.5 to about 3 g/cm³, or about 0.1 to about 2 g/cm³.

In the carbon composites, the carbon microstructures are held together by a binding phase. The binding phase comprises a binder which binds carbon microstructures by mechanical interlocking. Optionally, an interface layer is formed between the binder and the carbon microstructures. The interface layer can comprise chemical bonds, solid solutions, or a combination thereof. When present, the chemical bonds, solid solutions, or a combination thereof may strengthen the interlocking of the carbon microstructures. It is appreciated that the carbon microstructures may be held together by both mechanical interlocking and chemical bonding. For example the chemical bonding, solid solution, or a combination thereof may be formed between some carbon microstructures and the binder or for a particular carbon microstructure only between a portion of the carbon on the surface of the carbon microstructure and the binder. For the carbon microstructures or portions of the carbon microstructures that do not form a chemical bond, solid solution, or a combination thereof, the carbon microstructures can be bound by mechanical interlocking. The thickness of the binding phase is about 0.1 to about 100 microns or about 1 to about 20 microns. The binding phase can form a continuous or discontinuous network that binds carbon microstructures together.

Exemplary binders include a nonmetal, a metal, an alloy, or a combination comprising at least one of the foregoing. The nonmetal is one or more of the following: SiO₂, Si; B; or B₂O₃. The metal can be at least one of aluminum; copper; titanium; nickel; tungsten; chromium; iron; manganese; zirconium; hafnium; vanadium; niobium; molybdenum; tin; bismuth; antimony; lead; cadmium; or selenium. The alloy includes one or more of the following: aluminum alloys; copper alloys; titanium alloys; nickel alloys; tungsten alloys; chromium alloys; iron alloys; manganese alloys; zirconium alloys; hafnium alloys; vanadium alloys; niobium alloys; molybdenum alloys; tin alloys; bismuth alloys; antimony alloys; lead alloys; cadmium alloys; or selenium alloys. In an embodiment, the binder comprises one or more of the following: copper; nickel; chromium; iron; titanium; an alloy of copper; an alloy of nickel; an alloy of chromium; an alloy of iron; or an alloy of titanium. Exemplary alloys include steel, nickel-chromium based alloys such as Inconel*, and nickel-copper based alloys such as Monel alloys. Nickel-chromium based alloys can contain about 40-75% of Ni and about 10-35% of Cr. The nickel-chromium based alloys can also contain about 1 to about 15% of iron. Small amounts of Mo, Nb, Co, Mn, Cu, Al, Ti, Si, C, S, P, B, or a combination comprising at least one of the foregoing can also be included in the nickel-chromium based alloys. Nickel-copper based alloys are primarily composed of nickel (up to about 67%) and copper. The nickel-copper based alloys can also contain small amounts of iron, manganese, carbon, and silicon. These materials can be in different shapes, such as particles, fibers, and wires. Combinations of the materials can be used.

The binder used to make the carbon composites can be micro- or nano-sized. In an embodiment, the binder has an average particle size of about 0.05 to about 250 microns, about 0.05 to about 50 microns, about 1 micron to about 40 microns, specifically, about 0.5 to about 5 microns, more specifically about 0.1 to about 3 microns. Without wishing to be bound by theory, it is believed that when the binder has a size within these ranges, it disperses uniformly among the carbon microstructures.

When an interface layer is present, the binding phase comprises a binder layer comprising a binder and an interface layer bonding one of the at least two carbon microstructures to the binder layer. In an embodiment, the binding phase comprises a binder layer, a first interface layer bonding one of the carbon microstructures to the binder layer, and a second interface layer bonding the other of the microstructures to the binder layer. The first interface layer and the second interface layer can have the same or different compositions.

The interface layer comprises one or more of the following: a C-metal bond; a C—B bond; a C—Si bond; a C—O—Si bond; a C—O-metal bond; or a metal carbon solution. The bonds are formed from the carbon on the surface of the carbon microstructures and the binder.

In an embodiment, the interface layer comprises carbides of the binder. The carbides include one or more of the following: carbides of aluminum; carbides of titanium; carbides of nickel; carbides of tungsten; carbides of chromium; carbides of iron; carbides of manganese; carbides of zirconium; carbides of hafnium; carbides of vanadium; carbides of niobium; or carbides of molybdenum. These carbides are formed by reacting the corresponding metal or metal alloy binder with the carbon atoms of the carbon microstructures. The binding phase can also comprise SiC formed by reacting SiO₂ or Si with the carbon of carbon microstructures, or B₄C formed by reacting B or B₂O₃ with the carbon of the carbon microstructures. When a combination of binder materials is used, the interface layer can comprise a combination of these carbides. The carbides can be salt-like carbides such as aluminum carbide, covalent carbides such as SiC and B₄C, interstitial carbides such as carbides of the group 4, 5, and 6 transition metals, or intermediate transition metal carbides, for example the carbides of Cr, Mn, Fe, Co, and Ni.

In another embodiment, the interface layer comprises a solid solution of carbon such as graphite and a binder. Carbon has solubility in certain metal matrix or at certain temperature ranges, which can facilitate both wetting and binding of a metal phase onto the carbon microstructures. Through heat-treatment, high solubility of carbon in metal can be maintained at low temperatures. These metals include one or more of Co; Fe; La; Mn; Ni; or Cu. The binder layer can also comprise a combination of solid solutions and carbides.

The carbon composites comprise about 20 to about 95 wt. %, about 20 to about 80 wt. %, or about 50 to about 80 wt. % of carbon, based on the total weight of the carbon composites. The binder is present in an amount of about 5 wt. % to about 75 wt. % or about 20 wt. % to about 50 wt. %, based on the total weight of the carbon composites. In the carbon composites, the weight ratio of carbon relative to the binder is about 1:4 to about 20:1, or about 1:4 to about 4:1, or about 1:1 to about 4:1.

The carbon composites can optionally comprise a filler. Exemplary filler includes one or more of the following: carbon fibers; carbon black; mica; clay; glass fibers; ceramic fibers; or ceramic powder. Ceramic materials include SiC, Si₃N₄, SiO₂, BN, and the like. The filler can be present in an amount of about 0.5 to about 50 wt. %, about 0.5 to about 40 wt. %, about 0.5 to about 25 wt. %, 0.5 to about 10 wt. %, or about 1 to about 8%.

In an embodiment, the coating comprises one or more carbon composite foils. The carbon composite foils can be the same or different in terms of the thickness and the chemical makeup. To facilitate the binding between the coating and the substrate, when more than one carbon composite foils are present, the foil which is the closest to the substrate can have a greater amount of binder as compare to the foil which is further away from the substrate.

The coating formed on the substrate can completely cover the substrate or a surface of the substrate. The thickness of the coating can be from about 5 μm to about 10 mm, specifically about 10 μm to about 5 mm. In an embodiment, the coating is continuous and does not have voids, microvoids, fractures, or other defects, including pinholes and the like.

The coating can be bound to the substrate through a binding layer. The thickness of the binding layer can be about 50 nm to about 2 mm or about 100 nm to about 1 mm. The binding layer comprises one or more of the following: a solid solution of the binder in the carbon composite and the substrate; a material that is included in both the binder of the carbon composite and the substrate; or a solder. In the embodiments where an activation foil is used, the binding layer can further comprise reaction products of an activation material. If present, the reaction products are dispersed in the solid solution, the material which is included in both the binder of the carbon composite and the substrate; or the solder in the binding layer.

A variety of alloys can be used as solders for joining the coating to the substrate depending on the intended use or application method. As used herein, solders include the filler metals for brazing. Exemplary solders include Cu alloys, Ag alloys, Zn alloys, Sn alloys, Ni alloys, and Pb alloys. Other known solder materials can also be used. The solders can further include combinations of the alloys.

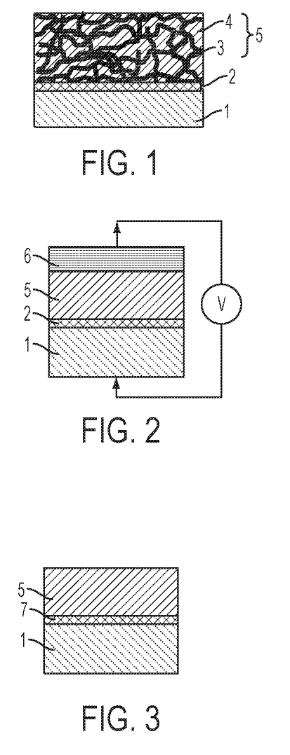

FIG. 1 is a schematic illustration of an article according to an embodiment of the disclosure. As shown in FIG. 1, the article comprises substrate 1, coating 5 and a binding layer 2 disposed between the substrate and the coating. The coating 5 comprises graphite 4 and an inorganic binder 3.

A method for coating a substrate includes: disposing a coating on a substrate; and binding the coating to the substrate. The coating comprises a carbon composite foil. As used herein, a carbon composite foil refers to a foil containing a carbon composite as described herein.

In an embodiment, binding the coating to the substrate comprises heating the coating and the substrate to form a binding layer between the coating and the substrate. The method of heating is not particularly limited. For example, the coated substrate can be heated in an oven at a temperature of about 350° C. to about 1400° C., specifically about 800° C. to about 1200° C. Optionally, the method further comprises pressing the coating and the substrate together during heating.

In another embodiment, binding the coating to the substrate comprises heating the coating and a surface of the substrate that the coating is disposed on by one or more of the following: direct current heating; induction heating; microwave heating; or spark plasma sintering. Optionally a force can be applied to the coating and the substrate to hold them together during heating.

An exemplary coating process is illustrated in FIG. 2. As shown in FIG. 2, an electric current passes through electrode 6 to substrate 1 and carbon composite foil 5. Heat is generated due to the higher electrical resistance where the coating and the substrate contact each other. The generated heat can melt or soften the binder in the carbon composite foil and/or the material on the surface of the substrate forming a binding layer 2 between the coating and the substrate. Upon cooling, the binding layer binds the coating to the substrate.

In an embodiment, the method further comprises disposing a solder between the coating and the substrate; applying heat to the solder; and binding the coating to the substrate. Because the solder can have a lower melting point or a lower softening temperature as compared to the inorganic binder in the carbon composite and the substrate material, less heat may be required if a solder is used. Optionally the method further comprises pressing the coating and the substrate together while applying heat to the solder.

In another embodiment, the method further comprises disposing an activation foil between a substrate and the coating; and exposing the activation foil to a selected form of energy to bind the coating to the substrate. FIG. 3 illustrates an article having an activation foil 7 disposed between a carbon composite coating 5 and a substrate 1. Alternatively, the activation foil can be laminated onto the carbon composite foil to form a coating. Then the coating, which comprises the carbon composite foil and the activation foil, can be disposed on a surface of the substrate. Optionally method further includes pressing the coating, the activation foil, and the substrate together while exposing the activation foil to a selected form of energy.

An activation foil comprises materials or reactants that can undergo intense exothermic reactions to generate large amounts of localized heat when exposed to a selected form of energy. The selected form of energy includes electric current; electromagnetic radiation, including infrared radiation, ultraviolet radiation, gamma ray radiation, and microwave radiation; or heat. Accordingly, activation foils can serve as a heat source for joining the coating to the substrate.

Thermite and self-propagating powder mixtures are usable as the activation material. Thermite compositions include, for example, a metal powder (a reducing agent) and a metal oxide (an oxidizing agent) that produces an exothermic oxidation-reduction reaction known as a thermite reaction. Choices for a reducing agent include aluminum, magnesium, calcium, titanium, zinc, silicon, boron, and combinations including at least one of the foregoing, for example, while choices for an oxidizing agent include boron oxide, silicon oxide, chromium oxide, manganese oxide, iron oxide, copper oxide, lead oxide and combinations including at least one of the foregoing, for example. Self-propagating powder mixtures include one or more of the following: Al—Ni (a mixture of Al powder and Ni powder); Ti—Si (a mixture of Ti powder and Si powder); Ti—B (a mixture of Ti powder and B powder); Zr—Si (a mixture of Zr powder and Si powder), Zr—B (a mixture of Zr powder and B powder); Ti—Al (a mixture of Ti powder and Al powder); Ni—Mg (a mixture of Ni powder and Mg powder); or Mg—Bi (a mixture of Mg powder and Bi powder).

The methods to prepare carbon composites have been disclosed in co-pending application Ser. No. 14/499,397, which is incorporated herein by reference in its entirety. One way to form the carbon composites in the coating is to compress a combination comprising carbon and a micro- or nano-sized binder to provide a green compact by cold pressing; and to compressing and heating the green compact thereby forming the carbon composites. In another embodiment, the combination can be pressed at room temperature to form a compact, and then the compact is heated at atmospheric pressure to form the carbon composite. These processes can be referred to as two-step processes. Alternatively, a combination comprising carbon and a micro- or nano-sized binder can be compressed and heated directly to form the carbon composites. The process can be referred to as a one-step process.

In the combination, the carbon such as graphite is present in an amount of about 20 wt. % to about 95 wt. %, about 20 wt. % to about 80 wt. %, or about 50 wt. % to about 80 wt. %, based on the total weight of the combination. The binder is present in an amount of about 5 wt. % to about 75 wt. % or about 20 wt. % to about 50 wt. %, based on the total weight of the combination. The graphite in the combination can be in the form of a chip, powder, platelet, flake, or the like. In an embodiment, the graphite is in the form of flakes having a diameter of about 50 microns to about 5,000 microns, preferably about 100 to about 300 microns. The graphite flakes can have a thickness of about 1 to about 5 microns. The density of the combination is about 0.01 to about 0.05 g/cm³, about 0.01 to about 0.04 g/cm³, about 0.01 to about 0.03 g/cm³ or about 0.026 g/cm³. The combination can be formed by blending the graphite and the micro- or nano-sized binder via any suitable methods known in the art. Examples of suitable methods include ball mixing, acoustic mixing, ribbon blending, vertical screw mixing, and V-blending. In another embodiment, the combination is made by vapor deposition. A “vapor deposition” process refers to a process of depositing materials on a substrate through the vapor phase. Vapor deposition processes include physical vapor deposition, chemical vapor deposition, atomic layer deposition, laser vapor deposition, and plasma-assisted vapor deposition. Examples of the binder precursors include triethylaluminum and nickel carbonyl. Different variations of physical deposition, chemical deposition, and plasma-assisted vapor deposition can be used. Exemplary deposition processes can include plasma assisted chemical vapor deposition, sputtering, ion beam deposition, laser ablation, or thermal evaporation. Through a vapor deposition process, the binder can at least partially fill the voids within the carbon microstructures.

Referring to the two-step process, cold pressing means that the combination comprising the graphite and the micro-sized or nano-sized binder is compressed at room temperature or at an elevated temperature as long as the binder does not significantly bond with the graphite microstructures. In an embodiment, greater than about 80 wt. %, greater than about 85 wt. %, greater than about 90 wt. %, greater than about 95 wt. %, or greater than about 99 wt. % of the microstructures are not bonded in the green compact. The pressure to form the green compact can be about 500 psi to about 10 ksi and the temperature can be about 20° C. to about 200° C. The reduction ratio at this stage, i.e., the volume of the green compact relative to the volume of the combination, is about 40% to about 80%. The density of the green compact is about 0.1 to about 5 g/cm³, about 0.5 to about 3 g/cm³, or about 0.5 to about 2 g/cm³.

The green compact can be heated at a temperature of about 350° C. to about 1400° C., specifically about 800° C. to about 1200° C. to form the carbon composites. In an embodiment, the temperature is about ±20° C. to about ±100° C. of the melting point of the binder, or about ±20° C. to about ±50° C. of the melting point of the binder. In another embodiment, the temperature is above the melting point of the binder, for example, about 20° C. to about 100° C. higher or about 20° C. to about 50° C. higher than the melting point of the binder. When the temperature is higher, the binder becomes less viscose and flows better, and less pressure may be required in order for the binder to be evenly distributed in the voids among the carbon microstructures. However, if the temperature is too high, it may have detrimental effects to the instrument.

The temperature can be applied according to a predetermined temperature schedule or ramp rate. The means of heating is not particularly limited. Exemplary heating methods include direct current (DC) heating, induction heating, microwave heating, and spark plasma sintering (SPS). In an embodiment, the heating is conducted via DC heating. For example, the combination comprising the graphite and the micro- or nano-sized binder can be charged with a current, which flows through the combination generating heat very quickly. Optionally, the heating can also be conducted under an inert atmosphere, for example, under argon or nitrogen. In an embodiment, the green compact is heated in the presence of air.

The heating can be conducted at a pressure of about 500 psi to about 30,000 psi or about 1000 psi to about 5000 psi. The pressure can be a superatmospheric pressure or a subatmospheric pressure. Without wishing to be bound by theory, it is believed that when a superatmospheric pressure is applied to the combination, the micro- or nano-sized binder is forced into the voids among carbon microstructures through infiltration. When a subatmospheric pressure is applied to the combination, the micro- or nano-sized binder can also be forced into the voids among the carbon microstructures by capillary forces.

In an embodiment, the desirable pressure to form the carbon composites is not applied all at once. After the green compact is loaded, a low pressure is initially applied to the composition at room temperature or at a low temperature to close the large pores in the composition. Otherwise, the melted binder may flow to the surface of the die. Once the temperature reaches the predetermined maximum temperature, the desirable pressure required to make the carbon composites can be applied. The temperature and the pressure can be held at the predetermined maximum temperature and the predetermined maximum pressure for about 5 minutes to about 120 minutes. In an embodiment, the predetermined maximum temperature is about ±20° C. to about ±100° C. of the melting point of the binder, or about ±20° C. to about ±50° C. of the melting point of the binder.

The reduction ratio at this stage, i.e. the volume of the carbon composite relative to the volume of the green compact, is about 10% to about 70% or about 20 to about 40%. The density of the carbon composite can be varied by controlling the degree of compression. The carbon composites have a density of about 0.5 to about 10 g/cm³, about 1 to about 8 g/cm³, about 1 to about 6 g/cm³, about 2 to about 5 g/cm³, about 3 to about 5 g/cm³, or about 2 to about 4 g/cm³.

Alternatively, also referring to a two-step process, the combination can be first pressed at room temperature and a pressure of about 500 psi to 30,000 psi to form a compact; the compact can be further heated at a temperature of about 350° C. to about 1200° C., specifically about 800° C. to about 1200° C. to make the carbon composite. In an embodiment, the temperature is about ±20° C. to about ±100° C. of the melting point of the binder, or about ±20° C. to about ±50° C. of the melting point of the binder. In another embodiment, the temperature can be about 20° C. to about 100° C. higher or about 20° C. to about 50° C. higher than the melting point of the binder. The heating can be conducted at atmospheric pressure in the presence or absence of an inert atmosphere.

In another embodiment, the carbon composite can be made from the combination of the graphite and the binder directly without making the green compact. The pressing and the heating can be carried out simultaneously. Suitable pressures and temperatures can be the same as discussed herein for the second step of the two-step process.

Hot pressing is a process that applies temperature and pressure simultaneously. It can be used in both the one-step and the two-step processes to make carbon composites.

The carbon composite foils can be made in a mold through a one-step or a two-step process. The carbon composite foils can also be made via hot rolling. In an embodiment, the carbon composite foils made by hot rolling can be further heated to allow the binder to effectively bond the carbon microstructures together.

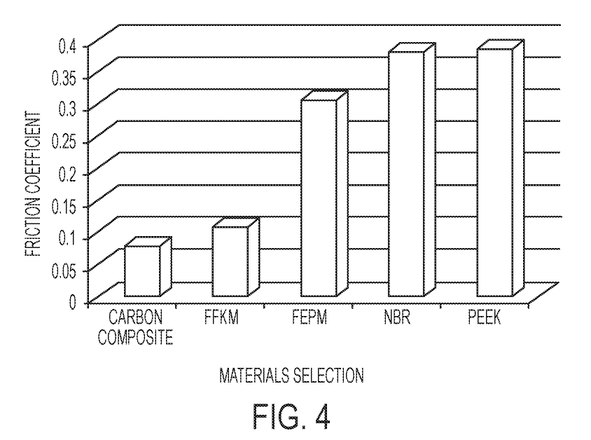

The carbon composite coatings can have excellent lubrication properties. FIG. 4 shows the friction testing results of carbon composite, FFKM (perfluoroelastomer available under the trade name Kalrez* from DuPont), FEPM (tetrafluoroethylene/propylene dipolymers), NBR (acrylonitrile butadiene rubber), and PEEK (polyetheretherketones). As shown in FIG. 4, among the samples tested, carbon composite provides the lowest friction coefficient.

The carbon composite coatings can have excellent thermal stability at high temperatures. In an embodiment, the carbon composite coating can have high thermal resistance with a range of operation temperatures from about −65° F. up to about 1200° F., specifically up to about 1100° F., and more specifically about 1000° F.

The carbon composite coatings can also have excellent chemical resistance at elevated temperatures. In an embodiment, the coatings are chemically resistant to water, oil, brines, and acids with resistance rating from good to excellent. For example, the coatings can be used continuously at high temperatures and high pressures, for example, about 68° F. to about 1200° F., or about 68° F. to about 1000° F., or about 68° F. to about 750° F. under wet conditions, including basic and acidic conditions. Thus, the coatings resist swelling and degradation of properties when exposed to chemical agents (e.g., water, brine, hydrocarbons, acids such as HCl, solvents such as toluene, etc.), even at elevated temperatures of up to 200° F., and at elevated pressures (greater than atmospheric pressure) for prolonged periods. The coatings are medium hard to extra hard with harness from about 50 in SHORE A up to about 75 in SHORE D scale.

Articles containing such coatings are useful for a wide variety of applications including but are not limited to electronics, atomic energy, hot metal processing, coatings, aerospace, automotive, oil and gas, and marine applications. For example, exemplary articles include coated bearings; coated valves such as safety valves; coated pipelines, for example, those used in chemical plants; coated pistons, and coated shafts. Coated bearings can be used in downhole tools such as ESP pump, drilling bit, or the like or in pharmacy or food industry where oil lubricants are prohibited for safety concerns. Coated pistons and coated shafts can be used in various machine or tool parts including engines and gears, and the like for applications in the oil and gas industry, automobile industry, or aerospace industry.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Or” means “and/or.” “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. “A combination thereof” means “a combination comprising one or more of the listed items and optionally a like item not listed.” All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A method for coating a substrate, the method comprising:
disposing a coating on a substrate, the coating comprising a carbon composite foil; and
binding the coating to the substrate;
wherein the carbon composite foil comprises a carbon composite, the carbon composite comprising a carbon and a binder;
the binder comprises one or more of the following: SiO₂; Si; B; B₂O₃; a metal; or an alloy of the metal; and
the metal comprises one or more of the following: aluminum; copper; titanium; nickel; tungsten; chromium; iron; manganese; zirconium; hafnium; vanadium; niobium; molybdenum; tin; bismuth; antimony; lead; cadmium; or selenium.

2. The method of claim 1, wherein binding the coating to the substrate comprises heating the coating and the substrate to form a binding layer between the coating and the substrate.

3. The method of claim 2, further comprising pressing the coating and the substrate together during heating.

4. The method of claim 1, wherein binding the coating to the substrate comprises heating the coating and a surface of the substrate that the coating is disposed on by one or more of the following: direct current heating; induction heating; microwave heating; or spark plasma sintering.

5. The method of claim 4, further comprising pressing the coating and the substrate together during heating.

6. The method of claim 1, wherein the method further comprises disposing a solder between the coating and the substrate; applying heat to the solder; and binding the coating to the substrate.

7. The method of claim 6, further comprising pressing the coating and the substrate together while applying heat to the solder.

8. The method of claim 1, comprising laminating an activation layer to the carbon composite layer to form a coating, disposing the coating on the substrate so that the activation layer is positioned between the carbon composite foil and the substrate; and
exposing the activation foil to a selected form of energy to bind the coating to the substrate.

9. The method of claim 1 further comprising disposing an activation foil between a substrate and the coating; and exposing the activation foil to a selected form of energy to bind the coating to the substrate.

10. The method of claim 9, further comprising pressing the coating, the activation foil, and the substrate together while exposing the activation foil to the selected form of energy.

11. The method of claim 9, wherein the selected form of energy is one or more of the following: electric current; an electromagnetic radiation; or heat.

12. The method of claim 9, wherein the activation foil comprises one or more of the following: a thermite; Al—Ni; Ti—Si; Ti—B; Zr—Si, Zr—B; Ti—Al; Ni—Mg; or Mg—Bi.

13. The method of claim 12, wherein the thermite comprises a reducing agent and an oxidization agent; wherein the reducing agent comprises one or more of the following: aluminum; magnesium; calcium; titanium; zinc; silicon; or boron; and the oxidizing agent comprises one or more of the following: boron oxide; silicon oxide; chromium oxide; manganese oxide; iron oxide; copper oxide; or lead oxide.

14. The method of claim 1, wherein the substrate comprises one or more of the following: a metal; an alloy of the metal; or ceramics.

15. The method of claim 14, wherein the metal in the substrate comprises one or more of the following: magnesium; aluminum; titanium; manganese; iron; cobalt; nickel; copper; molybdenum; tungsten; palladium; chromium; ruthenium; gold; silver; zinc; zirconium; vanadium; or silicon.

16. The method of claim 1, wherein the coating has a thickness of about 5 μm to about 10 mm.

17. The method of claim 1, wherein the carbon composite comprises at least two carbon microstructures; and a binding phase disposed between the at least two carbon microstructures; and wherein the binding phase comprises the binder.

18. The method of claim 17, wherein the binding phase comprises a binder layer and an interface layer bonding one of the at least two carbon microstructures to the binder layer, wherein the interface layer comprises at least one of the following: a C-metal bond; a C—B bond; a C—Si bond; a C—O—Si bond; a C—O-metal bond; or a metal carbon solution.

19. The method of claim 1, wherein the carbon in the carbon composite comprises graphite.

20. The method of claim 1, wherein the carbon composite further comprises one or more of the following: carbon fibers; carbon black; mica; clay; glass fibers; ceramic fibers; or ceramic powder.
